(19) United States
(12) Patent Application Publication
(10) Pub. No.: US 2010/0332986 A1
(43) Pub. Date: Dec. 30, 2010

(54) EMBEDDED ELECTRONIC DEVICE AND METHOD FOR CONTROLLING MULTIMEDIA FILES THEREIN

(75) Inventor: Teng-Yu Tsai, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/620,084

(22) Filed: Nov. 17, 2009

(30) Foreign Application Priority Data
Jun. 26, 2009 (CN) 200910303761.3

(51) Int. Cl. G06F 3/01

(52) U.S. Cl. 715/719

(57) ABSTRACT

An embedded electronic device includes a display, a user interface (UI) module, a playback module, a playback control module, and a storage module. The UI module displays a UI window on the display and accepts input to send out a control command The playback control module controls the playback module according to control commands from the UI module and acquires an executing state from the playback module. The storage module is accessed by the UI module and the playback control module. The storage module records the control command from the UI module and the executing state from the playback control module. The UI module fetches the executing state from the storage module on demand.

### BACKGROUND

1. Technical Field

The disclosure generally relates to embedded electronic devices and methods for controlling multimedia files in the embedded electronic devices.

2. Description of Related Art

Embedded electronic devices, such as digital cameras, set-top boxes, digital picture frames, and others, provide many functions, including audio file playback. Playback operation is typically enabled through a user interface (UI) showing an operating state of a playback program. When the UI is shut off, playback is terminated concurrently. Thus, what is called for is an electronic device providing separate UIs for operations and playback, so that even when the operating UI is shut off, the playback can continue.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an embedded electronic device according to an embodiment.

FIG. 2 is another block view of the embedded electronic device of FIG. 1.

FIG. 3 is a flowchart of a method for controlling multimedia files in an embedded electronic device according to one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

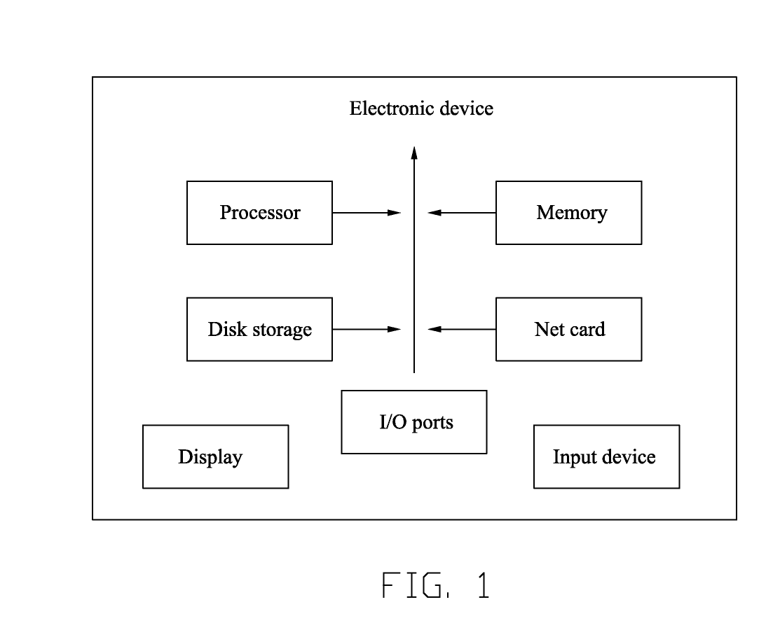

Referring to FIG. 1, an embedded electronic device may include a processor, a memory, a hard disk, a net card, input/output (I/O) ports, an input device and a display. The embedded electronic device carries an embedded operating system such as Linux.

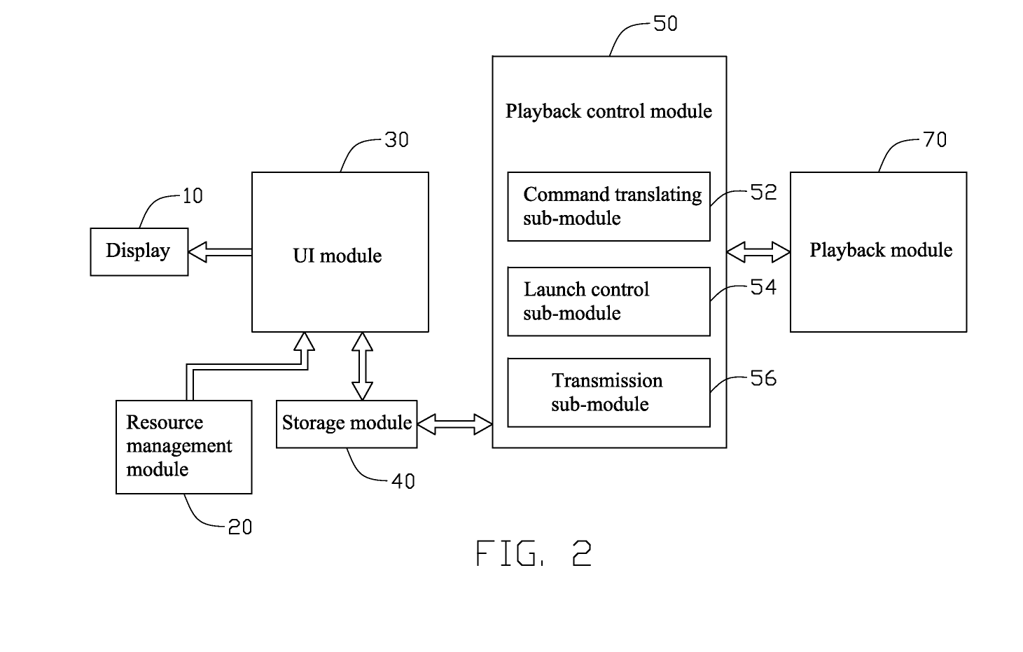

Referring to FIG. 2, in one embodiment, the embedded electronic device further includes a user interface (UI) module 30, a resource management module 20, a playback control module 50 and a playback module 70. A storage module 40 may be a block of memory that acts as a hard disk of the electronic device. The speed when memory is used far exceeds that with the hard disk, and files in the memory can be accessed much more quickly.

The UI module 30 provides a UI window on the display 10 to accept input generating a control command for storage into the storage module 40. The UI module 30 invokes the resource management module 20 to acquire uniform resource locators (URLs) of the multimedia files.

The playback control module 50 includes a command translating sub-module 52, a launch control sub-module 54 and a transmission sub-module 56. The command translating sub-module 52 translates the control command from the storage module 40. The launch control sub-module 54 launches the playback module 70 to play or pause a multimedia file. The transmission sub-module 56 can periodically read the control command from storage module 40 and transmit an executing state of the current multimedia file from the playback module 70 to the storage module 40. The executing state includes at least one of total duration, duration played, and album art of the current multimedia file.

The playback module 70 works as a background application. The playback module 70 can decode and play the multimedia file under control of the playback control module 50.

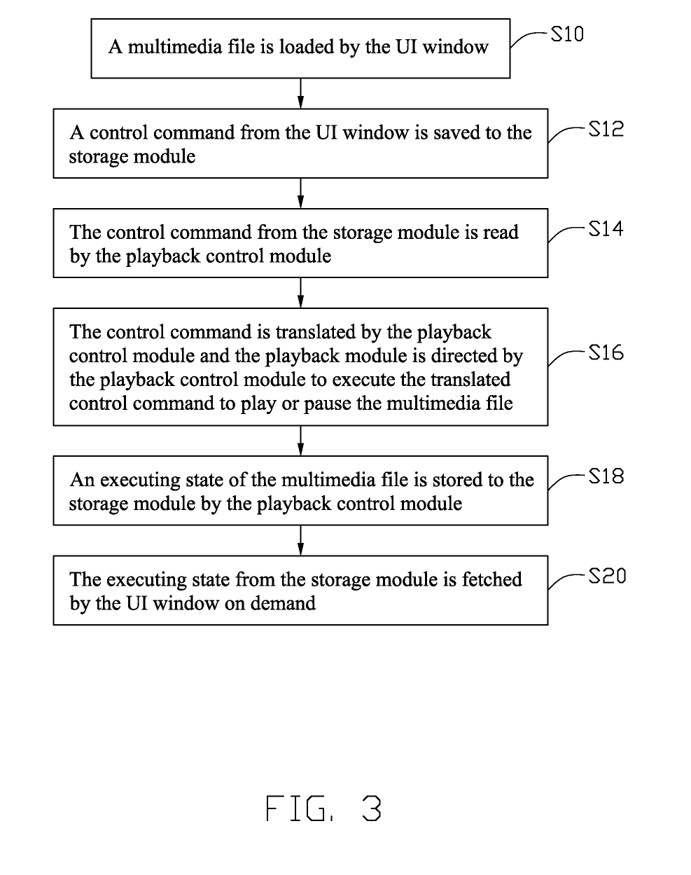

Referring to FIG. 3, it shows a method for controlling multimedia files in an embedded electronic device according to an embodiment.

In step S10, a multimedia file is loaded by the UI window.

In step S12, a control command from the UI window is saved to the storage module 40.

In step S14, the control command from the storage module 40 is read by the playback control module 50.

In step S16, the control command is translated by the playback control module 50 and the playback module 70 is directed by the playback control module 50 to execute the translated control command to play or pause the multimedia file.

In step S18, an executing state of the multimedia file is stored to the storage module 40 by the playback control module 50.

In step S20, the executing state from the storage module 40 is fetched by the UI window on demand.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An embedded electronic device comprising:
a display;
a user interface (UI) module capable of displaying a UI window on the display and accepting input to send out a control command;
a playback module for playing multimedia files;
a playback control module capable of controlling the playback module according to control command from the UI module and acquiring an executing state from the playback module; and
a storage module capable of being accessed by the UI module and the playback control module;
wherein the storage module is capable of recording the control command from the UI module and recording the executing state from the playback control module; and the UI module is capable of fetching the executing state from the storage module on demand.

2. The embedded electronic device of claim 1, wherein the storage module comprises of memory.

3. The embedded electronic device of claim 1, wherein the executing state comprises at least one of total duration, duration played, and album art of the current multimedia file.

4. The embedded electronic device of claim 1, wherein the UI module is capable of invoking a resource management module to acquire uniform resource locators of the multimedia files.

5. The embedded electronic device of claim 1, wherein the playback control module is capable of periodically reading the control command from the storage module.

6. A method for controlling multimedia files in an embedded electronic device comprising:
loading a multimedia file in response to input from a user interface (UI) window;
saving a control command from the UI window to a storage module;
reading the control command from the storage module by a playback control module
translating the control command and controlling a playback module to execute the translated control command; and
storing an executing state to the storage module by the playback control module.

7. The method of claim 6 wherein the storage module comprises of memory.

8. The method of claim 6, wherein the control command comprises playing the multimedia file or pausing the current multimedia file.

9. The method of claim 6, wherein the executing state comprises at least one of total duration, duration played, and album art of the multimedia file.

10. The method of claim 6 further comprising invoking a resource management module to acquire uniform resource a locator of the multimedia file by a user interface window before loading the multimedia file.

11. The method of claim 6 further comprising periodically reading the control command from the storage module by the playback control module.

12. The method of claim 6 further comprising fetching the executing state from the storage module by the UI window on demand.

13. A method for controlling multimedia files in an embedded electronic device comprising:
providing a display; a user interface (UI) module capable of displaying a UI window on the display and accepting input to send out control commands; a playback module for playing multimedia files; a playback control module capable of controlling the playback module according to control command from the UI module and acquiring an executing state from the playback module; and a storage module capable of being accessed by the UI module and the playback control module;
loading the multimedia file by the UI window;
saving the control command to the storage module;
reading the control command from the storage module by the playback control module;
translating the control command and controlling the playback module to execute the translated control command; and
storing the executing state to the storage module by the playback control module.
